(19) United States
(12) Patent Application Publication
(10) Pub. No.: US 2007/0241993 A1
(43) Pub. Date: Oct. 18, 2007

(54) LIQUID-CRYSTAL DISPLAY APPARATUS

(75) Inventors: Takuya Monden, Kumamoto (JP); Kenji Teramoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/697,866

(22) Filed: Apr. 9, 2007

(30) Foreign Application Priority Data
Apr. 18, 2006 (JP) JP2006-114264

(51) Int. Cl. G09G 3/20

(52) U.S. Cl. 345/58

(57) ABSTRACT

A front frame has a panel opening in an area corresponding to the display surface of a liquid-crystal panel. In the picture frame that corresponds to the boundary of the panel opening, two through holes are formed in each of the two sides that are parallel to the panel horizontal direction and in each of the two sides that are parallel to the panel vertical direction. Each through hole is oval-shaped, and its longer axis coincides with the direction in which the side extends. Accordingly, when the middle frame is placed under the front frame, panel guide portions formed as parts of the middle frame can be visually seen from outside in relatively large areas.

### BACKGROUND OF THE INVENTION

1. Field of the Invention

The present invention relates to a liquid-crystal display apparatus, and particularly to a liquid-crystal display apparatus in which a liquid-crystal panel is held between a front frame and a middle frame.

2. Description of the Background Art

In general, a liquid-crystal display apparatus is composed of a liquid-crystal panel and a flat-like light-source device accommodated in a housing formed of a front frame and a rear frame.

In the liquid-crystal panel, two transparent substrates are placed opposite each other at a given interval and hermetically bonded together at their peripheries with sealing material, and a liquid-crystal layer is enclosed between the two transparent substrates. Polarizers having polarizing property are bonded over the front and back surfaces of the liquid-crystal panel.

A tape carrier package (referred to as TCP), having flexibility, is electrically connected to the electrode terminal portion of the liquid-crystal panel, and the TCP has its input electrode terminal portion electrically connected to a printed wiring board (referred to as PWB) provided on the back of the flat-like light-source device.

In the assembly of such a liquid-crystal display apparatus, the flat-like light-source device is attached to a frame called a middle frame, and it is accommodated in a rear frame shaped like a box having a bottom and no top.

Then, the liquid-crystal panel is placed on the middle frame in a position opposite the light emitting surface of the flat-like light-source device, and the TCP having its input electrode terminal portion connected to the PWB is bent along the side of the rear frame. The PWB is then screwed to the back of the rear frame.

In this condition, the front frame, shaped like a box having a bottom and no top, is fitted from the liquid-crystal panel side, to accommodate the rear frame. Needless to say, the area of the front frame that corresponds to the liquid-crystal panel forms an opening.

A similarly structured liquid-crystal display apparatus is disclosed in Japanese Patent Application Laid-Open No. 2000-258756 (FIGS. 4 and 5), for example.

In the liquid-crystal display apparatus constructed as described above, the liquid-crystal panel is held between the middle frame and the front frame. Then, if the liquid-crystal panel is placed in a wrong position shifted from the correct position on the middle frame, the liquid-crystal panel will be pinched between the middle frame and the front frame and that portion will be broken.

In particular, when the liquid-crystal panel is broken in part, it may not cause problems in the initial stages but may cause inferior display in long-time use. It is thus difficult to detect such breakage in the initial stages. This problem becomes more serious as the thickness of the liquid-crystal panel is reduced, and becomes more difficult to detect as the thickness of the panel is reduced.

Also, producing a thinner liquid-crystal display apparatus requires thinning the front frame itself, which reduces the force to hold the liquid-crystal panel. If such a less firmly assembled liquid-crystal display apparatus undergoes impact when, e.g., dropped, the middle frame may be broken or the front frame may come off, which will result in breakage of the liquid-crystal panel and hence inferior display.

### SUMMARY OF THE INVENTION

An object of the present invention is to provide a liquid-crystal display apparatus which prevents the liquid-crystal panel from being pinched and broken between a middle frame and a front frame during the assembly of the liquid-crystal display apparatus. Also, a liquid-crystal display apparatus is provided which has this function and is capable of retaining the force to hold the liquid-crystal panel even when the liquid-crystal display apparatus is formed thinner.

According to an aspect of the present invention, a liquid-crystal display apparatus includes: a first frame shaped like a box having a bottom and having no top, and having an opening in its bottom in which a display surface of a liquid-crystal panel is exposed; and a second frame that is accommodated in the first frame and that holds the liquid-crystal panel, and the liquid-crystal panel is held between the first frame and the second frame. The second frame has a panel holder portion that holds the liquid-crystal panel and a peripheral portion that surrounds the panel holder portion like a bank, and the peripheral portion has a plurality of panel guide portions formed in a plurality of positions of the peripheral portion, and the plurality of panel guide portions project in plan view toward the liquid-crystal panel from the remaining portion. The first frame has a plurality of openings formed in positions that correspond to the plurality of panel guide portions of the second frame when the second frame is accommodated in the first frame.

As above, the first frame has a plurality of openings formed in positions that correspond to a plurality of panel guide portions of the second frame when the second frame is accommodated in the first frame. Accordingly, it is possible to visually check, during and after the fitting of the first frame, whether the liquid-crystal panel is correctly positioned in the vicinities of the panel guide portions. It is thus possible to fit the first frame while confirming that the liquid-crystal panel does not lie over the panel guide portions, so that the liquid-crystal panel is prevented from overlying the panel guide portions and from being broken, which makes it possible to produce a high-quality liquid-crystal display apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view illustrating the structure of a liquid-crystal display apparatus according to a preferred embodiment of the present invention;

FIGS. 2 and 3 are cross-sectional views illustrating the structure of the liquid-crystal display apparatus of the preferred embodiment of the present invention;

FIG. 4 is a plan view illustrating the structure of a middle frame;

FIG. 5 is a cross-sectional view illustrating the structure of a liquid-crystal display apparatus according to a first modification of the preferred embodiment of the present invention;

FIG. 6 is a cross-sectional view illustrating the structure of a liquid-crystal display apparatus according to a further improvement of the first modification of the preferred embodiment of the present invention;

FIG. 7 is a cross-sectional view illustrating the structure of a liquid-crystal display apparatus according to a second modification of the preferred embodiment of the present invention;

FIG. 8 is a partial cross-sectional view illustrating a method of assembling the liquid-crystal display apparatus of the second modification of the preferred embodiment of the present invention; and

FIG. 9 is a cross-sectional view illustrating the structure of a liquid-crystal display apparatus according to a third modification of the preferred embodiment of the present invention.

### DESCRIPTION OF THE PREFERRED EMBODIMENTS

### Preferred Embodiment

<Structure of Device>

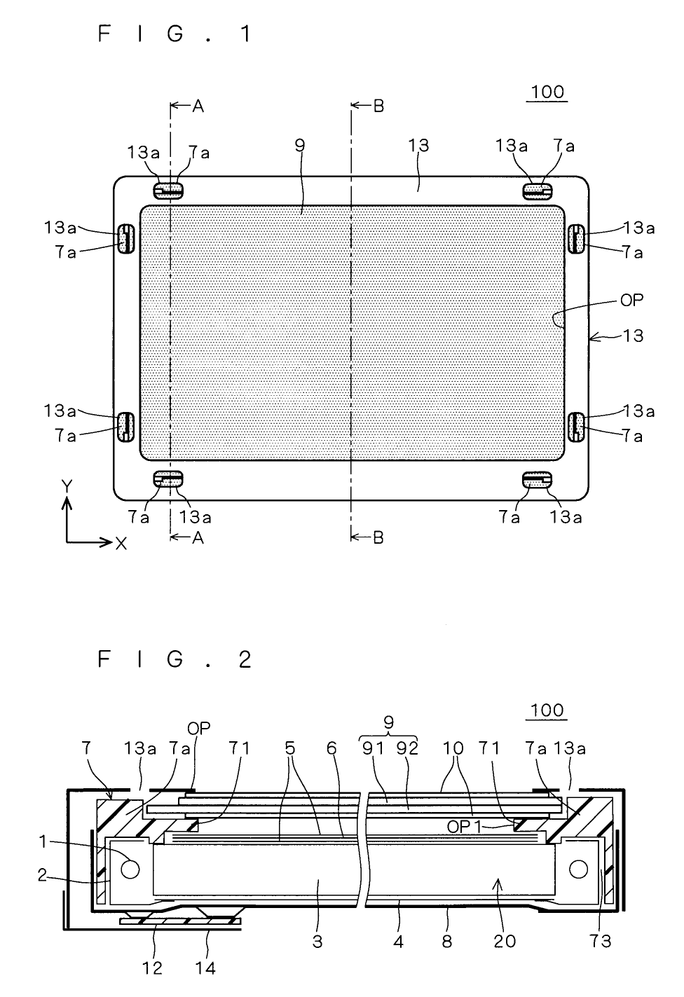

A preferred embodiment of the liquid-crystal display apparatus of the present invention will now be described referring to FIGS. 1 to 4.

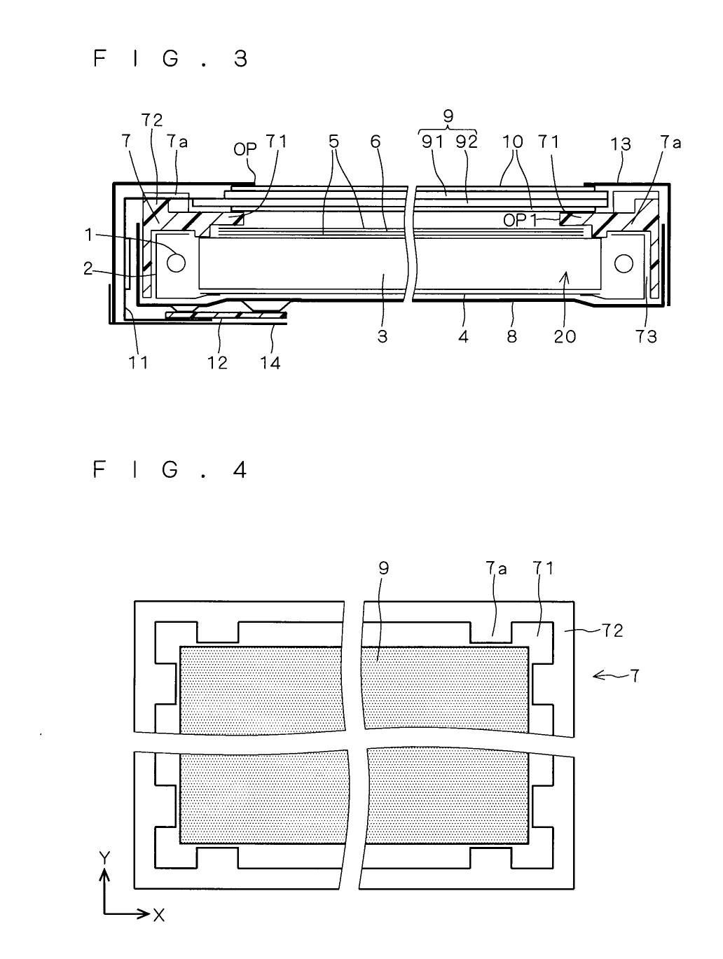

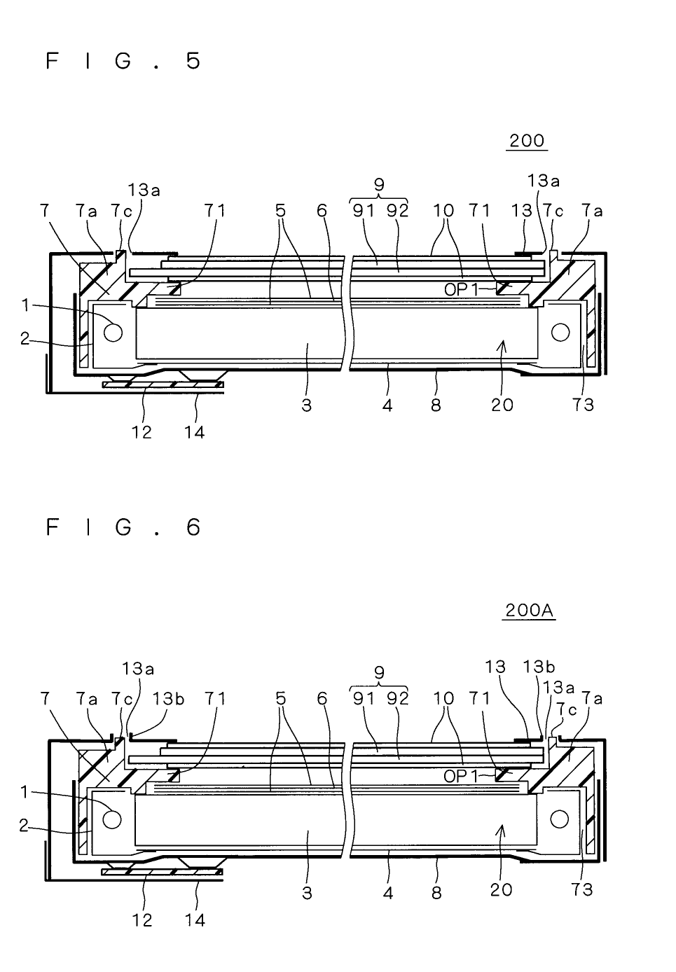

FIG. 1 is a plan view illustrating the structure of a liquid-crystal display apparatus 100 of the preferred embodiment. FIG. 2 shows the cross section taken along line A-A of FIG. 1 and seen from the direction indicated by the arrows, and FIG. 3 shows the cross section taken along line B-B of FIG. 1 and seen from the direction indicated by the arrows. FIG. 4 is a plan view illustrating the structure of a middle frame 7 (a second frame).

As shown in FIG. 1, the liquid-crystal display apparatus 100 has a front frame 13 (a first frame) having through holes 13a formed therein, where two through holes 13a are formed in the vicinity of each of the four corners of the front frame 13. More specifically, the front frame 13 has a panel opening OP in the area corresponding to the display surface of a liquid-crystal panel 9. And, in the picture frame that corresponds to the boundary around the panel opening OP, two through holes 13a are formed in each of the two sides that are parallel to the panel horizontal direction (X direction), and in each of the two sides that are parallel to the panel vertical direction (Y direction).

In each side, the individual through holes 13a are located near both ends of the side, but away from the corners of the front frame 13. Accordingly, two through holes 13a exist close to each other in the vicinity of each of the four corners of the front frame 13.

Each through hole 13a is oval-shaped, and its longer axis coincides with the direction in which the side extends. Accordingly, when the middle frame 7 is placed under the front frame 13, panel guide portions 7a formed as parts of the middle frame 7 can be visually seen from outside in relatively large areas.

Next, referring to FIG. 2, the sectional structure of the liquid-crystal display apparatus 100 will be described.

As shown in FIG. 2, the liquid-crystal panel 9 includes two transparent substrates 91 and 92 that are placed opposite each other at a given interval and hermetically bonded together at their peripheries with sealing material. A liquid-crystal layer is enclosed between the transparent substrates 91 and 92, and polarizers 10 having a polarizing property are bonded over the front side of the liquid-crystal panel 9 (over the surface of the transparent substrate 91) and over the back of the liquid-crystal panel 9 (over the surface of the transparent substrate 92).

A flat-like light-source device 20 is formed of lamps 1, reflectors 2, a light guide plate 3, a reflecting sheet 4, diffuser sheets 5, and a lens sheet 6, and the flat-like light-source device 20 is placed to face toward the display surface of the liquid-crystal panel 9.

The light guide plate 3 receives light from the lamps 1 functioning as light sources, and diffuses the light inside to supply uniform light toward the back of the liquid-crystal panel 9, and the lamps 1 are placed respectively opposite the two longer sides of the rectangular-shaped light guide plate 3.

The reflectors 2 are respectively placed to surround the two lamps 1, and they respectively reflect the light emitted from the lamps 1 and intensively radiate the light toward the sides of the light guide plate 3.

The reflecting sheet 4 is bonded over the back of the light guide plate 3 (over its main surface that is opposite to the liquid-crystal panel 9), and the diffuser sheets 5 and the lens sheet 6 are bonded over the front side of the light guide plate 3 (over its main surface that faces the liquid-crystal panel 9), with the lens sheet 6 sandwiched between two diffuser sheets 5.

The liquid-crystal panel 9 and the flat-like light-source device 20 are positioned by being mounted in the middle frame 7, and the middle frame 7 has a panel holder portion 71 for holding the liquid-crystal panel 9 and a light-source casing 73 for accommodating the flat-like light-source device 20.

The panel holder portion 71 is the area around a panel opening OP1 formed corresponding to the display surface of the liquid-crystal panel 9, and a peripheral portion 72, raised to a higher level, surrounds the panel holder portion 71 like a bank.

In plan view, the peripheral portion 72 has a plurality of projections that project from the remaining portion toward the liquid-crystal panel 9, and the projections form a plurality of panel guide portions 7a.

Among the plurality of panel guide portions 7a, each two that project from opposite sides of the peripheral portion 72 form a pair, and the liquid-crystal panel 9 is held between the twos of opposite panel guide portions 7a. The intervals between the twos of the panel guide portions 7a are set slightly larger than the dimensions of the liquid-crystal panel 9. In FIG. 2, it is set slightly larger than the dimension in the panel vertical direction, whereby the liquid-crystal panel 9 is accommodated between the panel guide portions 7a, and the movement of the liquid-crystal panel 9 in the panel vertical direction is restricted.

Similarly, as shown in FIG. 1, the panel guide portions 7a are arranged in pairs also in the panel horizontal direction, so as to restrict the movement of the liquid-crystal panel 9 in the panel horizontal direction. The movement of the liquid-crystal panel 9 is thus restricted in both directions, whereby the movement of the liquid-crystal panel 9 in the plane direction is restricted.

Now, FIG. 4 shows a plan view, seen from the front, of the middle frame 7 in which the liquid-crystal panel 9 is accommodated.

As shown in FIG. 4, two panel guide portions 7a project from each of the two sides parallel to the panel horizontal direction (X direction) and each of the two sides parallel to the panel vertical direction (Y direction), and the panel guide portions 7a of each side are positioned near both ends of the side, but away from the corners of the middle frame 7. Accordingly, two panel guide portions 7a exist close to each other in the vicinity of each of the four corners of the middle frame 7. The through holes 13a of the front frame 13 are positioned in correspondence with the positions of the panel guide portions 7a. The positions of the panel guide portions 7a are not limited to the positions explained above, but the panel guide portions 7a may be formed in other positions that do not overlap with interconnections to the liquid-crystal panel 9 and the like.

Referring back to FIG. 2, the light-source casing 73 will be described.

In the middle frame 7, the light-source casing 73 is an open area formed on the side opposite to the panel holder portion 71, and the light-source casing 73 has such a space that it can accommodate the flat-like light-source device 20 and it can restrict the movement of the accommodated flat-like light-source device 20 in the plane.

When the liquid-crystal panel 9 is mounted on the panel holder portion 71 and the flat-like light-source device 20 is accommodated in the light-source casing 73, then the light emitting surface of the flat-like light-source device 20 and the back surface of the liquid-crystal panel 9 face each other through the opening 73, and the light from the flat-like light-source device 20 irradiates the liquid-crystal panel 9.

The front frame 13 is shaped like a box having a bottom and no top. When the front frame 13 is fitted over the middle frame 7 with the liquid-crystal panel 9 accommodated therein, the panel opening OP formed in its bottom coincides with the display surface of the liquid-crystal panel 9, so that the display surface is exposed through the panel opening OP, and the middle frame 7 is entirely covered, except in its back.

Also, when a rear frame 8, which is shaped like a box having a bottom and no top, is fitted from the back of the middle frame 7, the middle frame 7 is entirely covered except in its front side, whereby the flat-like light-source device 20 is surrounded by the bottom of the rear frame 8 and the light-source casing 73, and the movement of the flat-like light-source device 20 in the vertical direction is thus restricted.

The rear frame 8 is sized such that it can accommodate the middle frame 7, but it is smaller than the front frame 13 and therefore the sides of the rear frame 8 are covered by the front frame 13.

As shown in FIG. 3, a tape carrier package (TCP) 11 having flexibility is electrically connected to an electrode terminal portion (not shown) of the liquid-crystal panel 9, and the TCP 11 has its input electrode terminal portion (not shown) electrically connected to a printed wiring board (PWB) 12 fixed to the back of the rear frame 8 with, e.g., screws.

Also, in order to protect the TCP 11 and the PWB 12, an insulating film 14 made of, e.g., PET (polyethylene terephthalate), covers the side of the front frame 13 and the PWB 12. The insulating film 14 is fixed to the front frame 13 and the rear frame 8 with, e.g., adhesive tape (not shown).

In the assembly of the liquid-crystal display apparatus 100 thus constructed, the flat-like light-source device 20 is accommodated in the light-source casing 73 of the middle frame 7, and the middle frame 7 is placed in the rear frame 8. Then, the liquid-crystal panel 9 is mounted on the panel holder portion 71 of the middle frame 7, the TCP 11 connected with the PWB 12 is bent along the side of the rear frame 8, and the PWB 12 is screwed to the back of the rear frame 8.

Then, the front frame 13 is fitted over the liquid-crystal panel 9, so as to accommodate the rear frame 8.

At this time, if the liquid-crystal panel 9 is placed in a wrong position shifted from the correct position and the front frame 13 is fitted over it with the liquid-crystal panel 9 hanging over any of the panel guide portions 7a, then that part of the liquid-crystal panel 9 will be pinched and broken between the panel guide portion 7a and the front frame 13.

<Effects>

However, in the liquid-crystal display apparatus 100 of the preferred embodiment described above, the liquid-crystal panel 9 and the panel guide portions 7a holding it can be visually seen through the through holes 13a that are formed in the front frame 13 in the positions above the panel guide portions 7a. Accordingly, it is possible to fit the front frame 13 while checking whether the liquid-crystal panel 9 lies over the panel guide portions 7a, whereby the liquid-crystal panel 9 is prevented from overlying the panel guide portions 7a, and thus from being broken, and the liquid-crystal panel 9 is held in the correct position between the front frame 13 and the middle frame 7.

It is also possible to check the panel guide portions 7a through the through holes 13a after the front frame 13 has been fitted, so as to confirm that the liquid-crystal panel 9 is not broken. After the check, the through holes 13a may be covered and closed with adhesive tape or the like.

Some cuts may be formed in place of the through holes 13a, as long as the panel guide portions 7a can be visually seen after the front frame 13 has been fitted. That is, openings of any shape can be formed as long as the openings allow the panel guide portions 7a to be visually seen.

Also, the positions and the number of the through holes 13a are not limited to those exemplified above, but through holes 13a may be formed only in two sides that are parallel to the panel horizontal direction (X direction) or two sides that are parallel to the panel vertical direction (Y direction). Or, when panel guide portions 7a are formed in the centers of the individual sides, through holes 13a are formed in positions corresponding thereto.

<First Modification>

Next, a first modification of the preferred embodiment will be described referring to FIG. 5 illustrating the cross-sectional structure of a liquid-crystal display apparatus 200.

FIG. 5 is a diagram corresponding to FIG. 2 showing a cross section of the liquid-crystal display apparatus 100, and the same components as those of the liquid-crystal display apparatus 100 are shown at the same reference characters and are not described again here.

As shown in FIG. 5, the liquid-crystal display apparatus 200 has ribs 7c formed on the upper surfaces of the panel guide portions 7a of the middle frame 7, and the ribs 7c project toward the front frame 13.

The ribs 7c are positioned such that they are respectively inserted in the through holes 13a of the front frame 13 when the through holes 13a are placed above the panel guide portions 7a, and the height of the ribs 7c is determined to be equivalent to that of the through holes 13a, or determined such that they slightly project from the through holes 13a.

The provision of the ribs 7c offers enhanced resistance to impact, in addition to the effects of the liquid-crystal display apparatus 100.

That is, the ribs 7c and the through holes 13a engaging with each other restrict the movement of the liquid-crystal panel 9 in the plane direction in the middle frame 7, and also restrict the movement of the light guide plate 3 of the flat-like light-source device 20 in the plane direction. The light guide plate 3 is thus prevented from moving in the plane direction even when external impact is applied, and this prevents the middle frame 7 from being deformed by it to break the liquid-crystal panel 9, and also prevents the lamps 1 from being broken.

In addition, the positional relation between the front frame 13 and the middle frame 7 is restricted, which enhances the stiffness against torsion.

Accordingly, it is possible to maintain the force to hold the liquid-crystal panel 9 even when the liquid-crystal display apparatus is further thinned.

When the ribs 7c are provided to enhance the impact resistance, the impact resistance can be further enhanced by devising the through holes 13a.

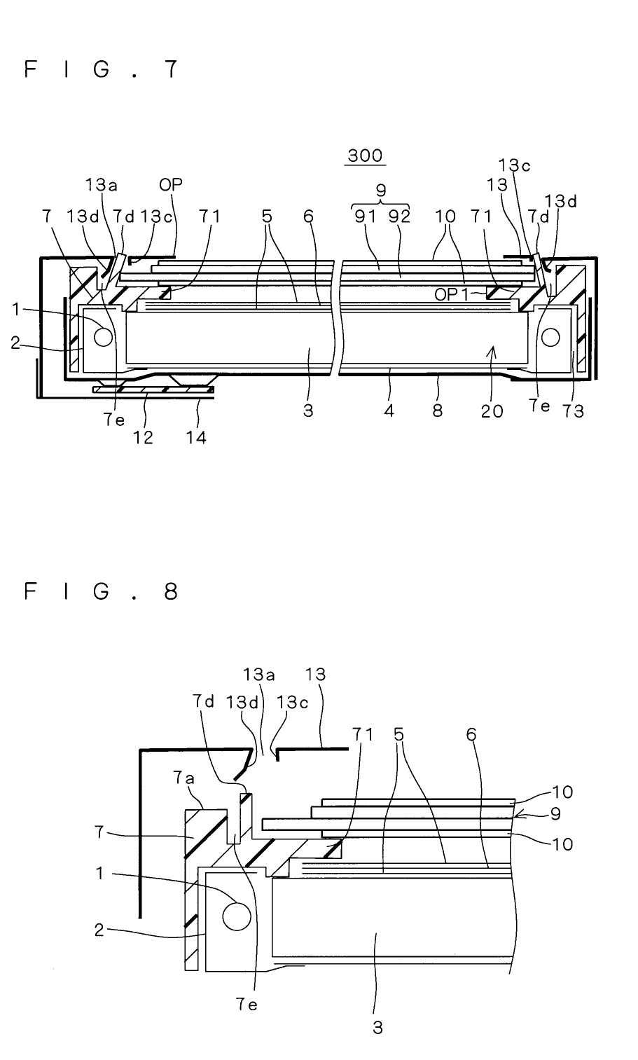

FIG. 6 illustrates the cross-sectional structure of a liquid-crystal display apparatus 200A having opening ribs 13b around the through holes 13a.

As shown with the liquid-crystal display apparatus 200A, each opening rib 13b projects outward around the whole periphery of the through hole 13a. The provision of the opening ribs 13b enhances the stiffness in the vicinities of the through holes 13a, and therefore the liquid-crystal display apparatus 200A offers further enhanced impact resistance and further enhanced torsion stiffness as compared with the liquid-crystal display apparatus 200.

In addition, the side of the through hole 13a and the side of the rib 7c form a relatively large sidewall. Accordingly, when one of the through hole 13a and the rib 7c mating together is made of resin and the other is made of metal, for example, side surface of the through hole 13a and the opening rib 13b come in contact in a larger area such that the contact pressure per unit area is reduced, and the resin is prevented from being shaved to be dust particles.

In FIG. 6, the opening ribs 13b are formed on the outer surface of the front frame 13 and project outward. However, the opening ribs 13b may be formed on the inner surface of the front frame 13 to project inward. The opening ribs 13b may respectively be formed only in part around the through holes 13a.

<Second Modification>

A second modification of the preferred embodiment will be described referring to FIG. 7 illustrating the cross-sectional structure of a liquid-crystal display apparatus 300.

FIG. 7 is a diagram corresponding to FIG. 2 showing a cross section of the liquid-crystal display apparatus 100, and the same components as those of the liquid-crystal display apparatus 100 are shown at the same reference characters and are not described again here.

As shown in FIG. 7, the liquid-crystal display apparatus 300 has grooves 7e formed in the panel guide portions 7a of the middle frame 7 and extending along the opposite sides of the liquid-crystal panel 9.

The grooves 7e are formed in the panel guide portions 7a in positions close to the liquid-crystal panel 9, and their depth is determined to reach at least half of the thickness of the panel guide portions 7a.

The provision of the groove 7e forms a rib 7d on the panel guide portion 7a. The rib 7d is formed higher than the surrounding part such that it can be inserted in the through hole 13a. Also, the position of the rib 7d is slightly shifted from the position of the through hole 13a such that the rib 7d positively engages with the through hole 13a.

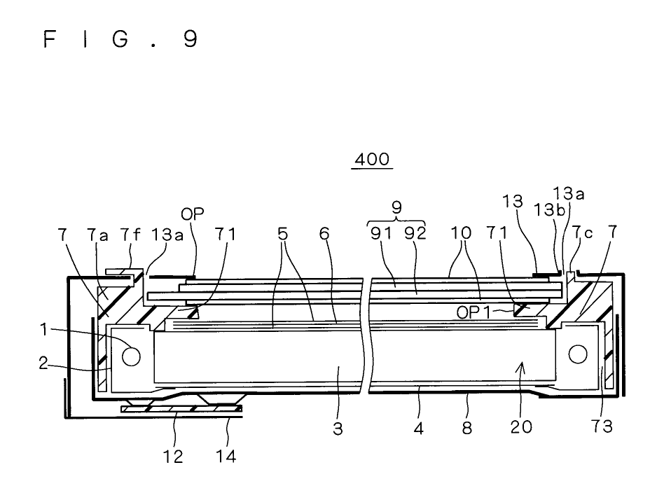

While FIG. 7 shows the liquid-crystal display apparatus 300 with the front frame 13 fitted thereover, FIG. 8 shows a panel guide portion 7a with the front frame 13 not yet fitted thereover. As shown in FIG. 8, before the front frame 13 is fitted, the rib 7d stands upright.

Also, the front frame 13 has an opening rib 13c and an opening rib 13d formed around the through hole 13a and projecting inward from the inner surface of the front frame 13.

The opening rib 13c projects vertically inward from the inner surface of the front frame 13, and the opening rib 13d is located closer to the groove 7e and projects at an inclination in correspondence with the inclination of the rib 7d, and the wall surface of the opening rib 13d is longer than that of the opposing opening rib 13c.

Then, the front frame 13 is fitted onto the middle frame 7, and the tip of the rib 7d comes in contact with the opening rib 13d. Then, the rib 7d is guided by the inclined opening rib 13d, and pushed over toward the liquid-crystal panel 9.

The provision of the groove 7e allows the rib 7d to be easily pushed over, and the rib 7d thus leans over the liquid-crystal panel 9. Thus, the liquid-crystal panel 9 is retained not only by the front frame 13 but also between the ribs 7d and the panel holder portion 71 of the middle frame 7, and its impact resistance is enhanced both in the plane direction and the thickness direction.

When it is difficult to form the inclined opening rib 13d and the opening rib 13c continuously around the through hole 13a, they may be formed separately.

<Third Modification>

A third modification of the preferred embodiment will be described referring to FIG. 9 illustrating the cross-sectional structure of a liquid-crystal display apparatus 400.

FIG. 9 is a diagram corresponding to FIG. 2 showing a cross section of the liquid-crystal display apparatus 100, and the same components as those of the liquid-crystal display apparatus 100 are shown at the same reference characters and are not described again here.

As shown in FIG. 9, in the liquid-crystal display apparatus 400, a panel guide portion 7a of the middle frame 7 has a rib 7c or a rib 7f formed on its upper surface, and the rib 7c is formed to project to the front frame 13 and the rib 7f is approximately L-shaped in cross section.

The rib 7c is provided on one of two opposite panel guide portions 7a in a pair, and the rib 7f is provided on the other.

The rib 7c is positioned such that it is inserted in the through hole 13a of the front frame 13 when the through hole 13a is placed above the panel guide portion 7a, and its height is determined to be equivalent to that of the through hole 13a or to slightly project from the through hole 13a. An opening rib 13b, projecting outward, is formed around the through hole 13a in which the rib 7c is inserted. The provision of the rib 7c and the opening rib 13b offers the same effects as those of the liquid-crystal display apparatuses 200 and 200A.

The rib 7f has an upright portion that projects upright from the upper surface of the panel guide portion 7a, and a parallel portion that bends perpendicularly to the upright portion and extends in parallel with the liquid-crystal panel 9, and the parallel portion is bent away from the liquid-crystal panel 9.

With the rib 7f, the outer surface of the front frame 13 and the rib 7f positively engage with each other, so as to restrict the movement of the middle frame 7 in the vertical direction, whereby the impact resistance in the thickness direction is enhanced. The impact resistance in the plane direction is also enhanced.

The assembly work can be efficiently performed by forming the rib 7f in correspondence with a through hole 13a formed in one of the two sides of the front frame 13 that extend in parallel with the panel horizontal direction (X direction).

While the invention has been described in detail, the foregoing description is in all aspects illustrative and not restrictive. It is understood that numerous other modifications and variations can be devised without departing from the scope of the invention.

What is claimed is:

1. A liquid-crystal display apparatus comprising:
a first frame shaped like a box having a bottom and having no top, said first frame having a panel opening in its bottom in which a display surface of a liquid-crystal panel is exposed; and
a second frame that is accommodated in said first frame and that holds said liquid-crystal panel, said liquid-crystal panel being held between said first frame and said second frame,
wherein said second frame has a panel holder portion that holds said liquid-crystal panel and a peripheral portion that surrounds said panel holder portion like a bank,
said peripheral portion has a plurality of panel guide portions formed in a plurality of positions of said peripheral portion, said plurality of panel guide portions projecting in plan view toward said liquid-crystal panel from a remaining portion, and
said first frame has a plurality of openings formed in positions that correspond to said plurality of panel guide portions of said second frame when said second frame is accommodated in said first frame.

2. The liquid-crystal display apparatus according to claim 1,
wherein said plurality of panel guide portions respectively have ribs formed on their respective upper surfaces, said ribs projecting toward said first frame, and
said ribs are inserted respectively in said plurality of openings of said first frame.

3. The liquid-crystal display apparatus according to claim 1, wherein said first frame has opening ribs respectively formed at least partially around said plurality of openings, said opening ribs projecting from a surface of said first frame.

4. The liquid-crystal display apparatus according to claim 3, wherein said opening ribs are formed to project outward of said liquid-crystal display apparatus.

5. The liquid-crystal display apparatus according to claim 3, wherein said opening ribs are formed to project inward into said liquid-crystal display apparatus.

6. The liquid-crystal display apparatus according to claim 1,
wherein said plurality of panel guide portions respectively comprise:
grooves extending along opposing sides of said liquid-crystal panel; and
ribs provided along said grooves and engaging with the sides of said liquid-crystal panel at an inclination,
and wherein said first frame has opening ribs respectively formed at least partially around said plurality of openings, said opening ribs obliquely projecting from an inner surface of said first frame respectively in correspondence with the inclination of said ribs, and
said ribs are respectively guided by said opening ribs and thus inserted respectively in said plurality of openings.

7. The liquid-crystal display apparatus according to claim 1,
wherein at least one of said plurality of panel guide portions has an approximately L-shaped rib formed on its upper surface, said approximately L-shaped rib having an upright portion that projects upright from the upper surface and a parallel portion that bends perpendicularly to said upright portion and extends in parallel with said liquid-crystal panel, and
said upright portion of said rib is inserted in a corresponding one of said plurality of openings, and said parallel portion of said rib extends outside said opening away from said liquid-crystal panel and engages with an outer surface of said first frame.
